(19) United States
(12) Patent Application Publication
(10) Pub. No.: US 2025/0392805 A1
(43) Pub. Date: Dec. 25, 2025

(54) ELECTRONIC EQUIPMENT WITH TRANSLUCENT COVER AND ASSOCIATED OPERATING METHOD

(71) Applicant: SAGEMCOM BROADBAND SAS, Bois-Colombes (FR)

(72) Inventors: Radu NEDELCU, Bois-Colombes (FR); Vincent-Xavier REYNAUD, Bois-Colombes (FR)

(21) Appl. No.: 19/201,342

(22) Filed: May 7, 2025

(30) Foreign Application Priority Data
Jun. 25, 2024 (FR) FR2406822

(51) Int. Cl. H04N 23/57; H04N 21/443; H04N 23/50

(52) U.S. Cl. CPC H04N 23/57; H04N 21/443; H04N 23/50

(57) ABSTRACT

An electronic equipment includes a casing provided with at least one opening, an image capture device, a shutter movably mounted in the casing between a working state and a resting state so that, when the shutter is in its working state, the image capture device views the exterior of the casing via the opening, and, when the shutter is in its resting state, the shutter conceals the opening for the image capture device, the equipment comprising a cover movably mounted in the casing between a retracted state and a protection state so that, when the cover is in its protection state and the shutter is in its working state, the image capture device views the exterior of the casing via the opening and a translucent zone of the cover. A corresponding operating method.

The present invention relates to the field of electronic equipment integrating at least one image capture device.

The present invention also relates to an operating method of the standby of such an equipment.

The present invention also relates to a computer program and an associated recording medium.

### BACKGROUND OF THE INVENTION

It is known from the prior art that an electronic equipment, such as a set-top box, can integrate a camera enabling a user to make video calls.

This type of set-top box must, however, comply with European regulations on standby power consumption.

Usually, this standby mode is controlled either manually by the user directly or automatically after a given time lapse when the set-top box is not used.

Unfortunately, during this lapse of time, the camera can continue to record images, which is problematic from a point of view of the user's privacy if the set-top box is no longer being used.

### Object of the Invention

The invention aims in particular, to provide an operating solution of the standby of an electronic equipment that is more respectful of the user's privacy.

### SUMMARY OF THE INVENTION

For this purpose, according to the invention, an electronic equipment is proposed, comprising:
a casing provided with at least one opening,
an image capture device having a field of view,
a shutter movably mounted in the casing between at least a working state and a resting state so that, when the movable shutter is in its working state, the image capture device, in use, can view the exterior of the casing via the opening, and, when the shutter is in its resting state, the shutter conceals the opening for the image capture device.

According to the invention, the electronic equipment comprises a cover movably mounted in the casing between at least a retracted state and a protection state so that, when the cover is in its protection state and the shutter is in its working state, the image capture device can view, in use, the exterior of the casing via the opening and a translucent zone of the cover.

As a result, the translucent cover enables to blur the images acquired when it is in a protection state.

Thus, even if the image capture device continues to observe the exterior of the electronic equipment, the user's privacy is much better respected.

The cover being partially masked, it makes the image sufficiently blurry to make it impossible to identify a user, but sufficiently clear to identify the movements. The cover enables to distinguish contrasts without precisely distinguishing the shapes.

Advantageously, when the cover is in a protection state, it is visible by the user, who thus, has no doubt about its activation.

The terms “top”, “bottom”, “front”, “back”, etc. should be understood according to the operating position of the electronic equipment when it is resting on a planar structure, which is preferably parallel to the horizontal.

Optionally, the cover is integrated into the shutter.

Optionally, the shutter is movably mounted in the casing between a first position in which the shutter is in its working state and the cover in its retracted state, a second position in which the shutter is in its working state and the cover is in its protection state, and a third position in which the shutter is in its resting state.

Optionally, the shutter is slidably mounted on the casing between its three positions.

Optionally, the cover is independent of the shutter.

Optionally, one of the shutter or cover is movably mounted on the exterior of the casing and the other of the shutter or cover is movably mounted inside the casing.

Optionally, the cover is tinted.

Optionally, the electronic equipment is a set-top box.

Optionally, the electronic equipment comprises at least one control unit connected to the image capture device, the control unit being able to make the electronic equipment switch into each of at least three different operating modes which are a nominal mode, a light standby mode and a deep standby mode.

Optionally, the control unit is able to make the electronic equipment switch between the light standby mode and the deep standby mode, and vice versa, from at least one image transmitted by the image capture device when the cover is in its protection state and the shutter is in its working state.

Optionally, the control unit is able to make the electronic equipment switch between the light standby mode and the deep standby mode, and vice versa, from at least one image transmitted by the image capture device also when the cover is in its retracted state and the shutter is in its working state.

Optionally, the control unit is able to make the electronic equipment switch between the light standby mode and the deep standby mode, and vice versa, from only an upper part of at least one image transmitted by the image capture device when the cover is in its protection state and the shutter is in its working state.

The invention also relates to an operating method of the standby of an electronic equipment as mentioned above, the method comprising at least the steps of:
analysing images acquired by the image capture device, when the cover is in its protection state and the shutter is in its working state, in order to detect a movement of at least one element present on the images,
switching the set-top box equipment to the deep standby mode if the set-top box equipment was in the light standby mode if no movement is detected in a given time interval or switching the set-top box equipment to the light standby mode if the set-top box equipment was in the deep standby mode and that movement is detected.

Optionally, the switching from deep standby mode to light standby mode is carried out if the detected movement has a speed greater than a given threshold.

Optionally, the method comprises the additional steps of:
analysing images acquired by the image capture device, when the cover is in its retracted state and the shutter is in its working state, in order to detect a movement of at least one element present on the images,
switching the set-top box equipment to the deep standby mode if the set-top box equipment was in the light standby mode if no movement is detected in a given time interval or switching the set-top box equipment to the light standby mode if the set-top box equipment was in the deep standby mode and that movement is detected.

The invention also relates to a computer program comprising instructions that lead an electronic box as mentioned above, to execute the method as mentioned above.

The invention also relates to a computer-readable storage medium on which the computer program such as specified above is recorded.

Other features and advantages of the invention will become apparent on reading the following description of particular and non-limiting embodiments of the invention.

### BRIEF DESCRIPTION OF THE DRAWINGS

Reference will be made to the accompanying drawings, among them:

FIG. 1a is a schematic top view of a portion of an electronic equipment according to a first embodiment of the invention, in a first configuration;

FIG. 1b is a schematic view of the portion of the electronic equipment shown in FIG. 1a, in the second configuration;

FIG. 1c is a schematic view of the portion of the electronic equipment shown in FIG. 1a, in the third configuration;

FIG. 2a is a schematic top view of a portion of an electronic equipment, according to a second embodiment of the invention, in a first configuration;

FIG. 2b is a schematic view of the portion of the electronic equipment shown in FIG. 2a, in the second configuration;

FIG. 2c is a schematic view of a portion of the electronic equipment shown in FIG. 2a, in a third configuration.

### DETAILED DESCRIPTION OF THE INVENTION

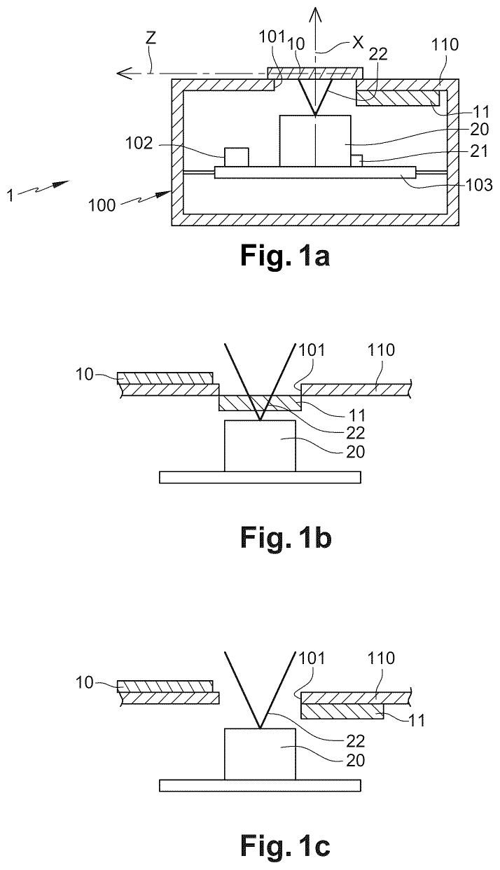

With reference to FIGS. 1a and 1b, an electronic equipment 1 according to a particular embodiment of the invention is described.

The electronic equipment 1, is in this case, a set-top box.

The electronic equipment 1 comprises a casing 100. The casing 100 has a top wall, a bottom wall and at least one side wall interconnecting the top wall and the bottom wall. Preferably, the bottom wall and the top wall are parallel to each other. By way of example, the bottom wall and the top wall are rectangular or square in shape, preferably with rounded edges. For example, four side walls interconnect the top wall and the bottom wall. For example, the side walls extend in parallel with each other in pairs. For example, each of the side walls extends orthogonally to at least one out of the bottom wall and the top wall, preferably to both the bottom and the top wall.

The casing 100 is generally in the shape of a rectangular parallelepiped. The casing 100 preferably has rounded edges, not sharp edges.

The casing 100 is shaped so that when it rests on a support, its bottom wall and its top wall extend in parallel with the support, and its side walls extend orthogonally to the support.

The casing 100 is provided with at least one opening 101. Preferably, the opening 101 is formed in a side wall of the casing 100. The opening 101 thus opens to a first end inside the casing 100 and to a second end on the exterior of the casing 100. The opening 101 extends along a first axis X through the side wall of the casing 100. In this case, the first axis X is horizontal when the casing 100 rests on a horizontal plane.

The electronic equipment 1 also comprises at least one control unit 102 of the electronic equipment 1. The control unit 102 is or comprises for example, a processor, a microcomputer or a microcontroller or any other means.

The electronic equipment 1 also comprises an image capture device that is in communication with the control unit 102.

The image capture device comprises, for example, a camera 20 and an operating member 21 of the camera. The operating member 21 comprises or is, for example, a processor, such as a digital signal processor (DSP), a microcomputer or a microcontroller, or any other means. The operating member 21 may or may not be remote from the camera 20 and/or integrated or not into the camera 20. It will thus be understood, that the operating member 21 is dedicated to the camera 20 and is preferably dedicated solely to the camera 20. The operating member 21 is thus, different from the control unit 102 which takes care of all the electronic equipment 1 and therefore, has a more general role than the operating member 21.

The image capture device and/or the control unit 102 is for example carried by a printed circuit board 103 fixed to one or more walls of the casing 100.

The camera 20 is positioned inside the casing 100 so that the exterior of the casing can be viewed via the opening 101.

Typically, the camera 20 has a field of view 22 that faces the opening 101 when the camera is switched on. As a result, at least one portion of the field of view of the camera 20 extends through the first opening 101. Typically, the field of view 21 of the camera 22 is centred around at least one viewing axis. Preferably, said viewing axis extends in parallel with the first axis X. The field of view 22 preferably extends coaxially with the first axis X and/or with the opening 101.

Preferably, the camera 20 is fixedly mounted with respect to the casing 100. The camera 20 is thus fastened to at least one wall of the casing either directly or indirectly. In the present example, the camera 20 is fixed indirectly (via the printed circuit board 103) to the casing 100.

The side wall of the casing 100 in which the opening 101 is formed thus forms the front wall 110 of the casing 100, i.e. the wall of the casing 100 intended to face the user.

The electronic equipment 1 also comprises a shutter 10 of the camera 20.

For example, the shutter 10 is arranged on the exterior of the casing 100. The shutter 10 is arranged, in this case, in front of the front wall 110 of the casing 100.

The shutter 10 is movably mounted relative to the casing 100. For example, the shutter 10 is movably mounted in the casing 100 by at least one translational movement, preferably by a single translational movement. For example, the shutter 10 is movably mounted in the casing 100 along a third axis Z, which is in this case, orthogonal to the first axis X. The third axis Z, in this case, extends horizontally when the casing 100 rests on a horizontal plane.

Preferably, the shutter 10 and/or the casing 100 are shaped so that the shutter 10 can move relative to the casing 100 between two end positions in which the shutter 10 is abutted against a portion of the casing 100.

It will thus be understood, that the shutter 10 is movably mounted on the casing 100 between:
a first end position, called the resting state of the shutter 10 (FIG. 1a),
   a second end position, called the working state of the shutter 10 (FIG. 1b and FIG. 1c).

In its resting state, the shutter 10 is arranged in the casing so as to extend facing the opening 101 of the casing 100. The field of view 22 is then concealed by the shutter 10. As a result, the camera 20 cannot view the exterior of the casing 100.

In its working state, the shutter 10 is arranged in the casing so as to be offset from the opening 101 of the casing 100. As a result, the camera 20 can view the exterior of the casing 100.

The electronic equipment 1 also comprises a protective cover 11. The cover 11 comprises at least one translucent portion. It should be noted that an object is described as translucent if it lets light pass through but does not allow other objects to be clearly discerned through it, due to multiple anisotropic refractions of the light rays. It is thus different from both a transparent object, which lets light pass through and allows objects to be discerned through it, and an opaque object, which absorbs or reflects the light rays. A translucent object diffuses the light as it is transmitted through it, making it difficult to observe through said object as everything will appear blurry.

Said portion may be coloured or may be uncoloured. For example, said portion is made of tinted polycarbonate and, for example, polycarbonate tinted with titanium dioxide.

Preferably, said light-transmitting portion forms the entire part constituting the cover 11. Thus, the entire cover 11 is, in this case, translucent.

For example, the cover 11 is arranged inside the casing 100. It is therefore understood, that the cover 11 is arranged behind the front wall 110 of the casing 100. It is also understood that the movable shutter 10 is arranged in the casing 100 between the front wall 110 of the casing 100 and the camera 20. The user then uses the opening 101 to be able to move the cover 11 relative to the casing 100.

The cover 11 is movably mounted relative to the casing 100. For example, the cover 11 is movably mounted in the casing 100 by at least one translational movement, and preferably by a single translational movement. For example, the cover 11 is movably mounted in the casing 100 along a translational movement which is parallel to the third axis Z.

The cover 11 is, for example, shaped in a plate. The user can thus slide the plate along the corresponding rail of the casing 100. The plate is, for example, equipped with a tab enabling a user to be able to manipulate the cover 11 through the opening 101 of the casing 100.

Preferably, the cover 11 and/or the casing 100 are shaped so that the cover 11 can move relative to the casing 100 between two end positions in which the cover 11 is abutted against a portion of the casing 100.

It will thus be understood, that the cover 11 is movably mounted between:
a first end position, called the retracted state (FIG. 1a and FIG. 1c),
a second end position, called the protection state (FIG. 1b).

In its retracted state, the cover 11 is arranged in the casing 100 so as to be offset from the opening 101 of the casing 100. As a result, the camera 20 can view the exterior of the casing 100 without an intermediary, on the condition that the shutter 10 is itself in its working state.

In its protection state, the cover 11 is arranged in the casing so as to extend facing the opening 101 of the casing 100. The field of view of the camera 20 is then concealed by the translucent portion of the cover 11. As a result, the camera 20 can only view the exterior of the casing 100 through said portion (and on the condition that the shutter 10 is in the working state). It will be understood that the images acquired by the camera 20 are then blurred. In particular, they do not enable to clearly distinguish the people in front of the camera 20.

In the first embodiment, the cover 11 is an independent part of the shutter 10.

In the first embodiment, the movement of the cover 11 relative to the casing 100 is independent of the movement of the shutter 10 relative to the casing 100.

The user can use the electronic equipment 1 as described above in several ways.

The user can first place the shutter 10 in the resting state (regardless of the state of the cover 11) when not using the set-top box equipment 1, or at least when not using the camera 20.

The user can also place the shutter 10 in the working state and the cover 11 in the retracted state, to use the set-top box equipment 1 in the conventional manner, and in particular its camera 20.

The user can also place the shutter 10 in the working state and the cover 11 in the protection state when wishing to temporarily blur the images acquired by the camera 20.

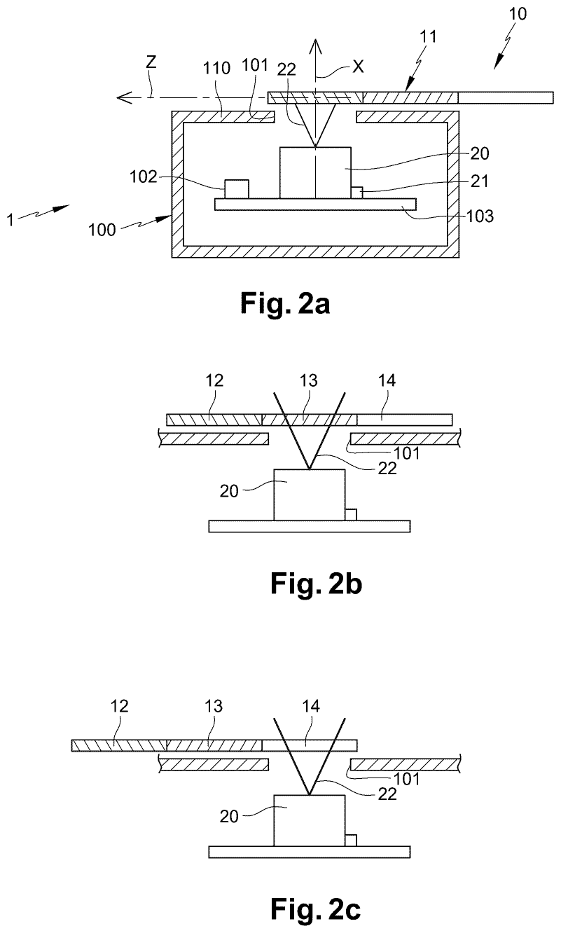

With reference to FIGS. 2a to 2c, there follows a description of a second embodiment. While in the first embodiment, the cover 11 and the shutter 10 formed two separate parts, in the second embodiment, the cover 11 is carried by the shutter 10. Preferably, the cover 11 and the shutter 10 form a single piece. The cover 11 and the shutter 10 are thus see in movement.

The shutter 10 is furthermore, arranged so as to always have at least one zone facing the orifice 101 and therefore, the casing 100.

For this purpose, the shutter 10 has three separate zones: a first opaque zone 12 (acting as the shutter 10 in the resting state), a second translucent zone 13 (acting as the cover 11) and a third transparent zone 14 (acting as the shutter 10 in the working state). The movement of the shutter 10 relative to the casing 100 brings one or the other of these zones opposite the camera 20 so that it can view the exterior of the casing 100 in a clear manner (via the third zone 14) or in a blurred manner (via the second zone 13) or cannot view the exterior of the casing 100 (via the first zone 12).

The shutter 10 is, for example, shaped as a bar extending longitudinally in a given direction, the three zones 12, 13, and 14 of the bar extending successively one after the other along this longitudinal direction. For example, the first zone 12, the second zone 13 and the third zone 14, follow one another along this longitudinal direction so that the second zone 13 is surrounded by the first zone 12 and the third zone 14. When the shutter 10 is in place on the casing 100, said given direction is preferably parallel to the third axis Z.

When the user slides the bar (for example, along the corresponding rails of the casing 100) a different zone of the shutter 10 can be brought opposite the camera 20. The bar is optionally equipped with a tab enabling a user to easily handle the bar.

For example, the shutter 10 is arranged on the exterior of the casing 100. For example, the shutter 10 is arranged in front of the front wall 110 of the casing 100.

Thus, the shutter 10 and/or the casing 100 are shaped so that the shutter 10 can move relative to the casing 100 between three positions: namely two end positions, in which the shutter 10 is abutted against a portion of the casing 100, and a neutral portion between the two end positions.

For example, the shutter 10 is movably mounted between:
a first end position, called the resting state for the shutter 10 and the retracted state for the cover 11 (FIG. 2a),
a neutral position (FIG. 2b), called the working state for the shutter 10 and the protection state for the cover 11,
a second end position, called the working state for the shutter 10 and the retracted state for the cover 11 (FIG. 2c).

In the first end position, the shutter 10 is arranged in the casing 100 so that its first zone 12 extends facing the opening 101 of the casing 100. The field of view of the camera 20 is then concealed by the movable shutter 10. As a result, the camera 20 cannot view the exterior of the casing 100.

In the neutral position, the shutter 10 is arranged in the casing 100 so that its second zone 13 extends facing the opening 101 of the casing 100. The field of view 22 of the camera 20 is then concealed by the translucent portion of the cover 11. As a result, the camera 20 can only view the exterior of the casing 100 through said portion (and on the condition that the shutter 10 is in the working state). It will be understood that the images acquired by the camera 20 are then blurred. In particular, they do not enable to clearly distinguish the people present in front of the camera.

In the second end position, the shutter 10 is arranged in the casing 100 so that its third zone 14 extends facing the opening 101 of the casing 100. As a result, the camera 20 can view the exterior of the casing 100. without being impeded by the cover 11.

The user can use the electronic equipment 1 as described above in several ways.

The user can first place the shutter 10 in its first end position (resting state of the shutter 10 combined with the retracted state of the cover 11) when not using the set-top box equipment 1 or at least when not using the camera 20.

The user can also place the shutter 10 in the neutral position (working state of the shutter 10 combined with the protection state of the cover 11) when wishing to temporarily to blur the images acquired by the camera 20.

The user can also place the shutter 10 in its second end position (working state of the shutter 10 combined with the retracted state of the cover 11) to use the set-top box equipment 1 in the conventional manner and in particular its camera 20.

Apart from what has been described above, the second embodiment is identical to the first embodiment.

Whether in the case of the first embodiment or in the second embodiment, the electronic equipment 1 is preferably configured to be able to operate according to three different modes of operation:
a deep standby mode,
a light standby mode,
an active mode

Preferably, in the active mode, all components of the electronic equipment 1 are powered.

In the light standby mode, only part of the components of the electronic equipment 1 are powered (of which, at least the image capture device and at least one other component). Preferably, only the image capture device (therefore, including the camera 20 and its operating member 21) and the components having a long start-up time are powered. By “long” is meant for example, greater than twenty seconds and for example, greater than thirty seconds. At the very least, in the light standby mode, no signal is transmitted by the electronic equipment 1 to any additional equipment external to the electronic equipment 1 (such as a television set).

Preferably, in the deep standby mode, only part of the components of the electronic equipment 1 are powered (of which, the image capture device therefore, including the camera 20 and its operating member 21), it being understood that fewer components are powered than in the light standby mode. Preferably, only the image capture device (therefore, including the camera 20 and its operating member 21) remains powered. Naturally, in deep standby mode, no signal is transmitted by the electronic equipment 1 to any additional equipment external to the electronic equipment 1 (such as a television set).

The electronic equipment 1 will a period of time considered long (and for example, at least twenty seconds, and generally, at least thirty seconds, and generally between thirty seconds and one minute) to switch from its deep standby mode to its active mode.

The light standby mode is more expensive in terms of energy than the deep standby mode. However, the electronic equipment 1 will take less time to return to the active mode from the light standby mode than if it started from the deep standby mode. The electronic equipment 1 will indeed take only a few seconds (and typically less than ten seconds) to switch from the light standby mode to the active mode.

Preferably, the control unit 102 is able to make the electronic equipment 1 switch into each of the three above-mentioned modes.

In particular, the control unit 102 is able to make the electronic equipment 1 switch between the light standby mode and the deep standby mode, and vice versa, from at least one signal transmitted by the image capture device when the cover 11 is in its protection state and the shutter 10 is in its working state.

In use, when the cover 11 is in its retracted state and the shutter 10 is in its working state, the electronic equipment 1 is in its active mode. A video stream is thus generated by the electronic equipment 1.

If the user no longer wishes to use the electronic equipment 1, a switch to deep standby mode can be ordered (by voice command, by pressing a zone of the electronic equipment 1 or from a remote device such as a mobile phone or a remote control, etc.).

It will thus be understood, that the electronic equipment 1 can switch from the active mode to the deep standby mode (and vice versa) without necessarily passing through the light standby mode.

Nevertheless, the user may wish to switch the electronic equipment 1 only to light standby mode. In this case, the user moves the cover 11 into its protection state (the shutter 10 being in its working state). This preferably automatically causes the electronic equipment 1 to switch from its active mode to its light standby mode.

Alternatively, or in addition, the user can also command the electronic equipment 1 to switch from its active mode to its light standby mode (by voice command, by pressing on a zone of the electronic equipment 1 or of a remote device such as a mobile phone or a remote control, etc.). In any case, the camera 20 continues to acquire images since it is always powered. By positioning the cover 11 in its protection state, the images acquired by the camera 20 are blurred. This protects the user's privacy. In particular, it is always possible to identify the presence of a person on the images, but their personal characteristics (age, gender, face, etc.) are be deductible from said images.

The operating member 21 continues, in this case, to analyse the images acquired by the camera 20. Indeed, even if the images are blurred, at least one piece of information may be obtained from these images, such as information characteristic of a movement of at least one element present on the images. The information can thus be a speed, an acceleration, a distance travelled, etc. of said element. It is thus possible to estimate if an element visible by the camera 20 is movable relative itself. This would mean that the user is always present and can therefore, reopen the cover 11 at any time to use the electronic equipment 1 again.

As a result, the operating member 21 analyses the images to determine if an element is present on the images and movable on the images.

If such an element is present, then the operating member 21 takes no decision. The electronic equipment 1 remains in light standby mode.

However, if no moving element is present on the images at the end of a given time interval and/or at the end of a given number of studied images, then the operating unit 21 transmits a signal to the control unit which switches the electronic equipment 1 into deep standby mode. This switch is preferably carried out automatically.

The given time interval is for example, between 1 and 7 minutes and for example, between 2 and 5 minutes.

The number of images studied given is for example, between 2000 and 7000 images and for example, between 3000 and 6000 images.

As a result, the power consumption of the electronic equipment 1 is limited.

Naturally, the electronic equipment 1 can also return to its active mode state, after having temporarily been in its light standby mode state, and this without going through the deep standby mode. This will be the case, for example, if moving elements have always been detected on the images when the electronic equipment 1 was in light standby mode.

In deep standby mode, it is understood that the image capture device continues to acquire (blurred) images and analyse them.

As a result, the operating member 21 analyses the images to determine if an element is present on the images and movable on the images.

If no element is present, then the operating member 21 does not take any decision. The electronic equipment 1 remains in deep standby mode.

However, if a moving element is present on the images at the end of a given time interval and/or at the end of a given number of studied images, then the operating member 21 transmits a signal to the control unit 102 which switches the electronic equipment 1 into light standby mode. This switch is preferably carried out automatically.

The given time interval is for example, between 0.5 and 2 seconds and for example, between 1 and 2 seconds.

The number of images studied given is for example, between 10 and 70 images and for example, between 25 and 50 images.

The electronic equipment 1 is thus quickly ready to be used.

Naturally, the electronic equipment 1 can also return to its deep standby mode state, after having temporarily been in its light standby mode state, and this without going through the active mode. This will be the case, for example, if no moving element is detected on the images when the electronic equipment 1 is in light standby mode.

Preferably, the operating member 21 is configured to transmit a signal to the control unit 102, following the detection of movements or absence of movements on the images, only if this detection is relative to an upper part of the images.

This enables to avoid switching the electronic equipment 1 from one mode to another when the detected movement is that of a child or an animal.

Thus, by only studying the movement on the upper parts of the images, a risk of switching the electronic equipment 1 from one mode to another is limited if the detected movement is not that of an adult.

For example, the operating member 21 studies the movement of the elements over a height of the images of between X and the upper edge of the images, X being of between half of the image and the upper third of the images.

Preferably, the operating member 21 is configured to transmit a signal to the control unit 102 following the detection of movements or absence of movements on the images, only if this detection is relative to an element of which the speed of displacement is greater than a given threshold. The given threshold can therefore, be a speed threshold but also an acceleration threshold, a minimum distance threshold to be covered (in a given time interval for example, of between 0.5 and 2 seconds), etc.

This enables to avoid switching the electronic equipment 1 from one mode to another when the detected movement is that of a non-human element (cloud, shadow, etc.) of which the movements are slow.

Thus, by only studying the movement of fast elements on the images, a risk of switching the electronic equipment 1 from one mode to another is limited when the detected movement is not that of a human being.

The electronic equipment 1 thus described, enables to switch to standby manually by the user but also automatically after a lapse of time of non-use.

The electronic equipment 1 thus described, enables to detect the presence or the absence of at least one user while respecting their privacy. This detection enables to save energy by going into deep standby in the absence of a user and to return to light standby as soon as the user is present.

The detection is carried out using the image capture device advantageously already integrated into electronic equipment 1 on the market.

The detection of presence of people in front of the camera is thus carried out, without this being done to the detriment of a user's privacy.

Naturally, the invention is not limited to the embodiments described, but includes any variant entering into the scope of the invention such as defined by the claims.

In particular, the electronic equipment in this case, is a set-top box, but the invention can also be integrated to a computer, a television and any other electronic equipment integrating an image capture device (set-top box, Video Soundbox, etc.).

In particular, the casing 100 may be a cube, a parallelepiped, a cylinder, a prism or any other shape that allows the present invention to be integrated.

Whatever the intended embodiment, the shutter may be arranged at the exterior of the casing or inside the casing.

Whatever the intended embodiment, the cover may be arranged at the exterior of the casing or inside the casing.

The cover can thus be arranged at the exterior of the casing and the shutter arranged inside the casing.

Whatever the intended embodiment, the shutter may be shaped to have an orifice through which the image capture device may view the exterior of the casing when the shutter will be in the working state, said orifice being offset from the orifice of the casing through which the image capture device may view the exterior of the casing when the shutter is in the resting state in order to block the field of view of the image capture device.

Whatever the intended embodiment, the cover may be shaped to have an orifice through which the image capture device can view the exterior of the casing when the shutter is in the working state and the cover is in the retracted state, said orifice being offset from the orifice of the casing through which the image capture device can view the exterior of the casing when the cover is in the protection state so that the image capture device can only observe the exterior through the translucent portion of the cover.

Although here, the translucent portion of the cover is made by colouring a material (paint, pigment, dye, etc.), the translucent portion of the cover may be made differently. For example, said portion may be made of a frosted material, i.e. a material that has undergone a chemical or mechanical treatment (sand, graining, etc.) to lose its original transparency. Said portion may thus (regardless of the method chosen to make it translucent), be made of glass and/or plastic material.

Although here, the cover can be moved via the opening of the casing, the cover may be moved via another opening made in the casing. The same reasoning applies to the shutter.

The processing of the images used to decide on switching from one standby mode to another may include one or more features different from those indicated. For example, the processing of the images may also take into account the time of day in order to adapt its processing to the dimensions of shadows potentially on the images. For example, the displacement of an element on the images acquired during a given time lapse (for example between 0.5 and 2 seconds) may be estimated and compare this displacement to a predetermined threshold calculated from the relative speed of rotation between the sun and the earth.

Although here, the shutter has either only one masking zone or three zones (one masking, one translucent and one opaque), the shutter may comprise a different number of zones and for example, may comprise two zones (one masking and one translucent). In the latter case, no part of the shutter (nor the cover) will be in front of the opening when the shutter will be in the working state and the cover in the retracted state as in the first embodiment. In all cases, the zone of the shutter enabling the camera to be able to clearly view the exterior of the electronic equipment may be transparent and/or be provided with an orifice that can be aligned with the opening of the casing.

Although here, the cover has only one zone, the cover may have a larger number of zones and, for example, may comprise two zones (one transparent and/or provided with an orifice and one translucent).

The movement of the cover and/or shutter relative to the casing may be at least partially automatic.

Although here, the switch between the deep standby mode and the light standby mode (and vice versa) is carried out from at least one image transmitted by the image capture device when the cover is in its protection state and the shutter is in its working state, the switch between the deep standby mode and the light standby mode (and vice versa) may also be carried out from at least one image transmitted by the image capture device when the cover is in its retracted state and the shutter is in its working state. The operating method of the standby will then be the same as that described above when the cover is in its protection state and the shutter is in its working state.

1. An electronic equipment, comprising:
a casing provided with at least one opening,
an image capture device having a field of view,
a shutter movably mounted in the casing between at least a working state and a resting state so that, when the shutter is in its working state, the image capture device, in use, views the exterior of the casing via the opening, and when the shutter is in its resting state, the shutter conceals the opening for the image capture device,
characterised in that the electronic equipment comprises a cover movably mounted in the casing between at least a retracted state and a protection state so that, when the cover is in its protection state and the shutter is in its working state, the image capture device displays, in use, views the exterior of the casing via the opening and a translucent zone of the cover.

2. The electrical equipment according to claim 1, wherein the cover is integrated into the shutter.

3. The electronic equipment according to claim 2, wherein the shutter is movably mounted in the casing between a first position wherein the shutter is in its working state and the cover in its retracted state, a second position wherein the shutter is in its working state and the cover in its protection state, and a third position wherein the shutter is in its resting state.

4. The electronic equipment according to claim 3, wherein the shutter is slidably mounted on the casing between its three positions.

5. The electronic equipment according to claim 1, wherein the cover is independent from the shutter.

6. The electronic equipment according to claim 5, wherein one of the shutter or the cover is movably mounted on the exterior of the casing and the other of the shutter or the cover is movably mounted inside the casing.

7. The electronic equipment according to claim 1, wherein the cover is tinted.

8. The electronic equipment, according to claim 1, wherein the electronic equipment is a set-top box.

9. The electronic equipment according to claim 1, comprising at least one control unit connected to the image capture device, the control unit being able to make the electronic equipment switch into each of at least three different operating modes which are, a nominal mode, a light standby mode and a deep standby mode.

10. The electronic equipment according to claim 9, wherein the control unit is able to make the electronic equipment switch between the light standby mode and the deep standby mode, and vice versa, from at least one image transmitted by the image capture device when the cover is in its protection state and the shutter is in its working state.

11. The electronic equipment according to claim 10, wherein the control unit is able to make the electronic equipment switch between the light standby mode and the deep standby mode, and vice versa, from at least one image transmitted by the image capture device also when the cover is in its retracted state and the shutter is in its working state.

12. The electronic equipment according to claim 10, wherein the control unit is able to make the electronic equipment switch between the light standby mode and the deep standby mode, and vice versa, from only an upper part of at least one image transmitted by the image capture device when the cover is in its protection state and the shutter is in its working state.

13. An operating method of the standby of an electronic equipment according to claim 1, comprising at least the steps of:
analysing images acquired by the image capture device, when the cover is in its protection state and the shutter is in its working state, in order to detect a movement of at least one element present on the images,
switching the set-top box equipment to the deep standby mode if the set-top box equipment was in the light standby mode if no movement is detected in a given time interval or switching the set-top box equipment to the light standby mode if the set-top box equipment was in the deep standby mode and that movement is detected.

14. The operating method of the standby according to claim 12, wherein the switching from the deep standby mode to the light standby mode is carried out if the detected movement has a speed greater than a given threshold.

15. The operating method of the standby according to claim 13, further comprising the steps of:
analysing images acquired by the image capture device, when the cover is in its retracted state and the shutter is in its working state, in order to detect a movement of at least one element present on the images,
switching the set-top box equipment to the deep standby mode if the set-top box equipment was in the light standby mode if no movement is detected in a given time interval or switching the set-top box equipment to the light standby mode if the set-top box equipment was in the deep standby mode and that movement is detected.

16. (canceled)

17. A non-transitory computer-readable storage medium, on which is recorded a computer program comprising instructions which lead an electronic box, to execute an operating method of the standby of the electronic equipment according to claim 1, comprising at least the steps of:
analysing images acquired by the image capture device, when the cover is in its protection state and the shutter is in its working state, in order to detect a movement of at least one element present on the images,
switching the set-top box equipment to the deep standby mode if the set-top box equipment was in the light standby mode if no movement is detected in a given time interval or switching the set-top box equipment to the light standby mode if the set-top box equipment was in the deep standby mode and that movement is detected.
